(19) United States
(12) Patent Application Publication
(10) Pub. No.: US 2013/0212134 A1
(43) Pub. Date: Aug. 15, 2013

(54) STORAGE CONFIGURATION DISCOVERY

(71) Applicants: Vijay Ram S, Bangalore (IN); Krishnamurthy Vikram, Bangalore (IN)

(72) Inventors: Vijay Ram S, Bangalore (IN); Krishnamurthy Vikram, Bangalore (IN)

(21) Appl. No.: 13/370,018

(22) Filed: Feb. 9, 2012

(51) Int. Cl. G06F 17/30

(52) U.S. Cl. 707/827; 707/E17.005; 707/E17.01

(57) ABSTRACT

A system is provided that includes a plurality of storage network devices and a storage manager communicatively coupled to the plurality of storage network devices. The storage manager includes a discovery engine configured to collect configuration information from the plurality of storage network devices. The system also includes an object model that represents the storage network system and is updated based on the configuration information collected by the discovery engine. The system also includes a mapping file that guides the discovery engine during an update of the object model. The discovery engine is triggered to perform a limited update of the object model upon the completion of a storage management operation.

### BACKGROUND

A storage network may include large numbers of storage resources, such as multiple disk arrays, network-attached storage (NAS) devices, and other storage appliances. As a result, a large data center may have tens, hundreds, or even thousands of disk drives. In many data centers, the physical disk drives are assigned to groups of drives that are further grouped into pools of storage. Virtual disk drives, referred to herein as volumes, may then be provisioned from the pools of storage. The volumes appear as physical drives to client computers, which generally not have to have an actual map of the physical configuration of the storage arrays.

Information regarding the configuration of the storage network can be collected by a storage management utility. The configuration information collected by the storage management utility may be stored to an object model that represents the entire storage network. The object model may be periodically updated by the storage manager according to a predetermined data collection schedule.

### BRIEF DESCRIPTION OF THE DRAWINGS

Certain exemplary embodiments are described in the following detailed description and in reference to the drawings, in which:

FIG. 1 is a block diagram of storage network system, in accordance with embodiments;

FIG. 2 is a block diagram of a portion of a mapping file, in accordance with an exemplary embodiment of the present techniques;

FIG. 3 is a process flow diagram of a method for collecting configuration information from the storage network system, in accordance with an exemplary embodiment of the present techniques;

FIG. 4 is a block diagram of a non-transitory, computer readable medium that stores code for collecting configuration information from the storage network system, in accordance with embodiments.

### DETAILED DESCRIPTION OF SPECIFIC EMBODIMENTS

Embodiments described herein relate to techniques for performing configuration discovery in a storage network system. In a typical storage network system, configuration discovery is conducted periodically, according to a pre-determined schedule. During a scheduled update, the entire storage network system is inspected in a unidirectional manner, in other words, proceeding from parent storage objects to child storage objects. In accordance with embodiments of the present techniques, configuration discovery is performed in response to storage management operations that change the configuration of the storage network system, such as volume provisioning, storage pool provisioning, host security group provisioning, and switch zone provisioning, among others. The configuration discovery is limited to those storage objects that may have been affected by the storage management operation that triggered the configuration discovery. During the configuration discovery process, the relevant storage objects may be inspected in a bi-directional manner from child storage objects to parent storage objects and from parent storage objects to child storage objects. For example, the configuration discovery process may proceed from the storage object immediately affected by the storage management operation to the parents of the storage object and children of the storage object. By implementing a more limited discovery operation in response to storage management operations, storage administrators are provided with a more up-to-date representation of the configuration of the storage network system.

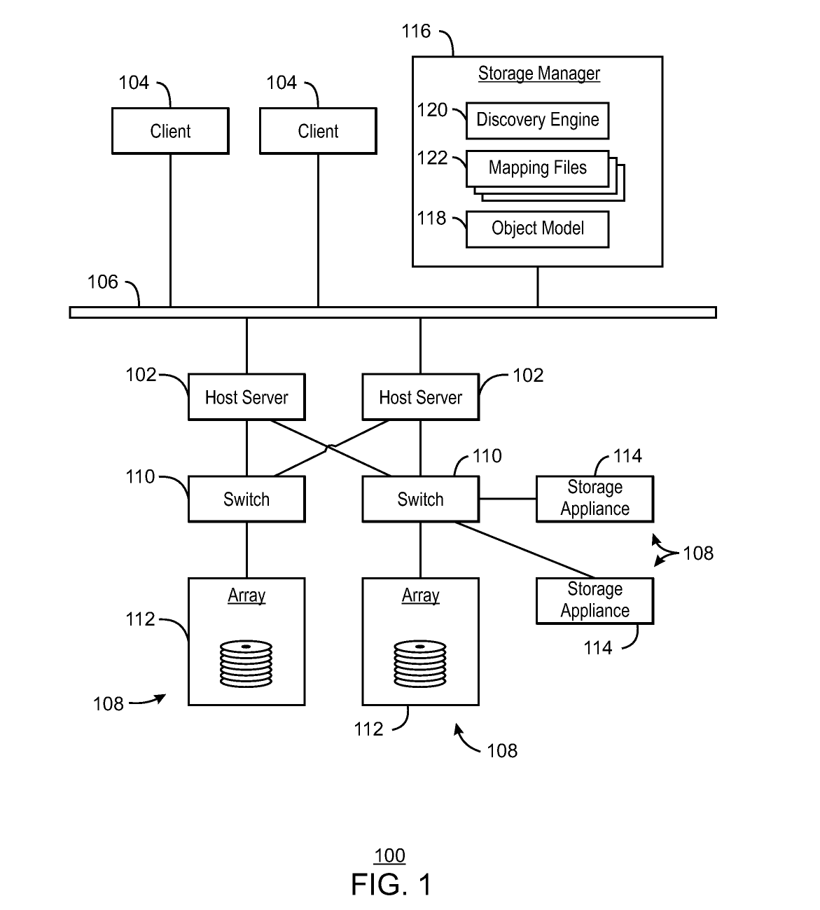

FIG. 1 is a block diagram of a storage network system, in accordance with embodiments. It will be appreciated that the storage network system 100 shown in FIG. 1 is only one example of a storage network system in accordance with embodiments. In an actual implementation, the storage network system 100 may include various additional storage devices and networks, which may be interconnected in any suitable fashion, depending on the design considerations of a particular implementation. For example, a large storage network system may often have many more hosts and storage arrays than shown in this illustration. The storage network system 100 may be accessed from one or more host servers 102. The host servers 102 may provide data, such as Web pages, database screens, applications, and other services, to one or more client computers 104 over a network 106. The network 106 may be a local area network (LAN), wide area network (WAN), a storage area network (SAN), or other network.

The host servers 102 may be connected to various storage network resources through a storage area network (SAN). As shown in FIG. 1, the host servers 102 may be coupled to various storage devices 108 through a matrix of SAN switches 110. The storage devices 108 may include one or more disk arrays 112, each of which may have numerous disk drives of multiple types. For example, the storage arrays may include units such as the StorageWorks Enterprise Virtual Array (EVA), available from the Hewlett Packard Corporation. The techniques described herein are not limited to the EVA, as they may be used with HP StorageWorks XP disk arrays, HP StorageWorks Modular Smart Arrays (MSA), and arrays available from other manufacturers. The storage network system 100 may also include additional storage appliances 114. For example, the storage appliances 114 may include a Network Attached Storage (NAS), tape library, or any other suitable storage device. The storage devices 108, switches 110, and other components of the storage network may be collectively referred to as storage network devices.

The storage network system 100 also includes a storage manager 116 for managing and monitoring the resources of the storage network system 100. For example, the storage manager 116 can be used to create storage pools, configure storage arrays 112, provision volumes for use by the clients 104, and the like. The storage manager 116 can also be used to change the routing configurations of the switches 110. In embodiments, the storage manager provides a graphical user interface to a storage administrator and enables the storage administrator to implement the desired configuration.

In embodiments, the storage manager 116 maintains an object model 118 of the storage network system 100 that represents the resources within the storage network system 100 and describes the capabilities and configuration of those resources. The physical and virtual resources within the storage network system 100 may be modeled as storage objects in the object model. The term “physical resources” refers to the actual storage network devices communicatively coupled to the storage network. Examples of physical objects that may be represented in the object model 118 include disk arrays, disks, ports, switches, servers, and the like. The term “virtual resources” refers to logical representations of the storage resources provided by the storage network devices. Examples of virtual objects that may be represented in the object model 118 include storage pools and volumes, among others. The object model 118 may be used by the storage manager 116 to configure the storage resources through various storage management operations. In response to a storage management operation, all objects within the object model 118 that are affected by the operation are updated to reflect the new configuration.

The update of the object model 118 may be performed by a discovery engine 120, which collects configuration information from the storage network devices affected by the storage management operation. The collection of configuration information from a storage network device is referred to herein as inspection. To inspect a selected one of the storage network devices, the storage manager 116 sends a message to the selected storage network device requesting the information and receives a return message from the storage network device that includes the requested information. In embodiments, the storage manager 116 communicates with some or all of the storage network devices using the common Information Model (CIM) defined by the Distributed Management Task Force (DMTF), the Storage Management Initiative-Specification (SMI-S) developed by the Storage Networking Industry Association (SNIA), or any other suitable communication protocol.

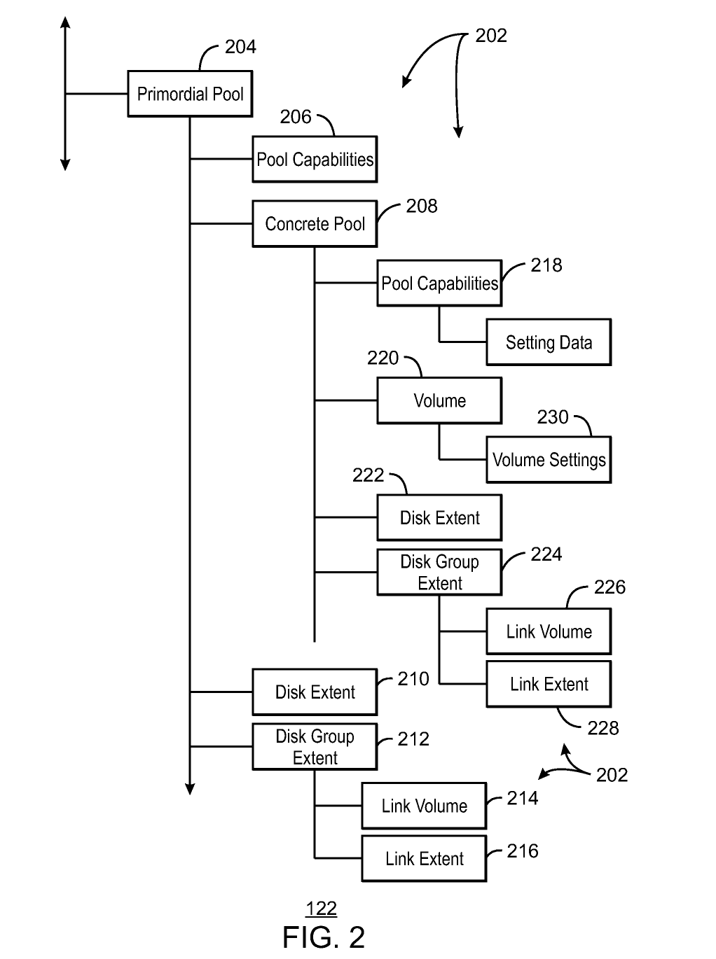

The discovery process is guided by the use of a mapping file 122, which provides a generic representation of the various possible storage objects and their relationships to one another. The mapping file 122 enables the discovery engine 120 to identify all of the storage objects affected by the storage management operation and guides the discovery engine in the collection of information from the affected storage network devices. In embodiments, the mapping file is an eXtensible Markup Language (XML) file that conforms to the CIM or SMI-S standard. Those storage network devices that are unaffected by the storage management operation are not inspected and the object model parameters corresponding to the unaffected storage network devices remain unchanged. In embodiments, the storage manager 116 may include or have access to a plurality of mapping files 122, which may used to support different device profiles. For example, different mapping files 122 may exist for servers, switches, storage arrays, tape libraries, and the like. Different mapping files may also be used to support different vendor specific properties. An example of a portion of a mapping file 122 is described in relation to FIG. 2.

FIG. 2 is a block diagram showing a portion of a mapping file, in accordance with embodiments. In embodiments, the mapping file 122 is a tree based data structure that contains linked nodes 202. Each node in the mapping file 122 may correspond with a type of object that exists the object model 118. The links between the nodes 202 in the mapping file 122 describe the relationships between the different types of objects. Each node 202 may include identifiers that identify the parent of the node 202 and the child or children of the node 202. Furthermore, each node 202 may include a set of discovery instructions configured to guide the discovery engine 120 (FIG. 1) to gather configuration information from the storage network devices relevant to that portion of the object model represented by the node 202. In embodiments, the mapping file 122 may be an Extensible Markup Language (XML) file. An XML-based mapping file may include a plurality of attributes contained within tags, which may be nested. The attributes can be used to identify the nodes of the object model, relationships between the nodes in tree structure of the mapping file, and the object properties to be collected during discovery. For the sake of clarity, only a portion of the mapping file 122 is shown. However, it will be appreciated that the mapping file 122 may include additional nodes corresponding to different aspects of the storage network system.

As shown in FIG. 2, the mapping file 122 may include a primordial pool node 204. A primordial pool is a parent storage pool from which multiple child storage pools can be created. A primordial pool represents all of the raw storage managed by an array system and cannot be directly used to create storage volumes. Multiple child storage pools, referred to as concrete pools can be created from a primordial pool. The primordial pool node 204 may have any number of direct child nodes, including a pool capabilities node 206, a concrete pool node 208, a disk extents node 210, and a disk group extents node 212. The pool capabilities node 206 is a node that represents capabilities supported by the primordial pool, such as redundancy level capabilities and the properties associated with each redundancy level. The disk extent node 210 is a node that represents the extents from each disk that are used to create the primordial storage pool. A disk extent is a contiguous area of storage on a physical disk drive that can be reserved for a particular file. When a process creates a file, the file-system management software may allocate extents to be used as storage space for the file. The disk group extent node 212 is a node that represents the group of physical disks that are part of the primordial pool. The disk group extent node 212 can include a link volume node 214 and a link extent node 216. The link volume node 214 represents all of the volumes that have been provisioned from the disk group. The link extent node 216 represents all of the disk extents that belong to the disk group.

The concrete pool node 208 is a node that represents concrete storage pools that are allocated from the primordial pool. A concrete pool is a storage pool from which storage volumes can be created. The concrete pool node 208 can have several direct child nodes, including a pool capabilities node 218, a disk extents node 222, and a disk group extents node 224. The pool capabilities node 218 is a node that represents capabilities supported by the concrete pool, such as redundancy level capabilities and the properties associated with each redundancy level. The disk extent node 222 is a node that represents the extents from each disk that are used to create the concrete storage pool. The disk group extent node 224 is a node that represents the group of physical disks that are part of the concrete pool. The group of physical disks represented by the disk group extent node 224 will be a subset of some or all of the physical disks represented by the disk group extent node 212 under the primordial pool node 204. Similar to the disk group extent node 212 under the primordial pool node 204, the disk group extend node 224 under the concrete pool node 208 can include direct child nodes such as a link volume node 226 and a link extent node 228. The link volume node 226 represents all of the volumes that have been provisioned from the disk group of the concrete pool. The link extent node 228 represents all of the disk extents that belong to the disk group of the concrete pool.

The volume node 220 is a direct child of the concrete pool node 208 and represents a volume that has been created from the concrete pool. A volume is a logical organization of storage resources that appears as a single storage entity to the client computers 104 and the host servers 102 (FIG. 1). A volume can reside on a single disk or can be distributed across a plurality of disks. The volume node 220 may have a direct child node referred to as the volume settings node 230. For example, the volume settings may include any settings relevant to the volume such as the redundancy level selected for the volume.

It will be appreciated that the nodes 202 in the mapping file 122 do not correspond with specific objects within the object model 118. Rather, the mapping file 112 relates to an overall generic organization of the object model 118. Thus, for example, if a change to a specific volume occurs, the mapping file informs the discovery engine that the specific volume, by virtue of the position volume node 220 in the mapping file 122, will be the direct child of some specific concrete pool within the object model 118. The instructions within the volume node 220 will guide the discovery engine to discover which specific concrete pool is the parent of the specific volume.

As explained above, the mapping file represented by the tree based data structure of FIG. 2 is used by the discovery engine to guide the inspection of storage network devices during an update of the data model 118 representing the storage network system 100 (FIG. 1). Each node in the mapping file describes a set of discovery instructions to be performed for the updating of the object model of the storage network system. The discovery engine 120 interprets the mapping file to determine how the object model 118 is defined for a particular device profile. As used herein, the term “replication” refers to the storing of the collected object information to the object model 118 of the storage network system 100.

The starting point for the discovery process depends on the particular storage management operation that triggered the discovery process. When a particular storage management operation has completed, the node corresponding to the storage object that was the subject of the storage management operation or was immediately affected by the storage management operation can be located in the mapping file 122. The storage object that was the subject of the storage management operation or was immediately affected by the storage management operation may be referred to herein as “the initial object,” and the corresponding node may be referred to as the initial node.

Information related to the initial object can be collected in accordance with the instructions contained within the corresponding initial node and used to replicate the initial object in the object model 118. The mapping file 122 can then be traversed to identify the parent node of the initial node. Once the parent node is identified, the configuration information of the parent can be retrieved in accordance with the instructions contained in that parent node. The collected information is used to replicate the corresponding object in the object model 118. This process can be repeated until the top-most node is reached, which may be a storage network system node (not shown), for example. The change in capacity at the storage network system level may be updated based on the received configuration information. Once the parents are replicated, the discovery engine 120 then proceeds to identify and replicate the children of the initial object. It will be appreciated that embodiments are not limited to a specific order of the traversal of the mapping file 122. In embodiments, the discovery process can proceed to children of the initial node and then to parents of the initial node.

In some cases, there may be associations of an object outside of the current sub-tree. For example, a volume is associated with the disk extents that are used to form the volume. Accordingly, the disk extents affected by the volume provisioning will also be updated. The disk extents node 22 however is the direct child of the concrete pool node 208 and is therefore not within the sub tree of the volume node. In embodiments, a node of the mapping file also includes information that is used to identify those relationships that are outside the current sub-tree. For example, an XML attribute referred to herein as a “target attribute” can be used to identify a particular node that outside of the current subtree and relates to an object that is associated in some way with the node.

A specific example of the discovery process is described further below, wherein the initial object is a storage volume. In this example, a network administrator provisions a new volume from a concrete pool, in which case an instance of CIM_StorageVolume may be returned by the storage device as the provisioning result. The CIM_StorageVolume instance identifies the volume under the concrete pool and identifies properties of the volume such as name, size, status, and the like. Based on the information provided by the CIM_StorageVolume instance, the exact position of the storage volume within the tree structure of the mapping file is obtained. In this example, the position of the storage volume is the volume node 220. The discovery process then begins at the volume node 220. The information contained in the volume node 220 is used to replicate the storage volume. The volume node 220 identifies the properties associated with the storage volume that are to be replicated to the object model 118. The storage volume may have additional properties that are not identified in the volume node and are thus ignored.

The discovery engine 120 can then acquire updated configuration information regarding other affected storage objects by traversing the mapping file from the volume node 220 to its parents and from the volume node 220 to its children. Thus, for example, at the volume setting node 230, data regarding the volume settings can be acquired by the discovery engine 120. At the concrete pool node 208, data regarding the configuration of the corresponding concrete pool can be acquired by the discovery engine 120. At the primordial pool node 204, data regarding the configuration of the corresponding primordial pool can be acquired by the discovery engine. This process can be progressively repeated up through the mapping file 122 until all of the parent nodes of the volume node 220 have been processed. Additionally, attributes may be used to identify other nodes in the mapping file 122 that represent storage objects that are outside of the volume node's sub tree, but are nevertheless affected by the volume provisioning operation. For example, a target attribute of the volume node 220 may be used to identify the disk extents node 222, which enables the disk extents that make up the provisioned volume to be updated.

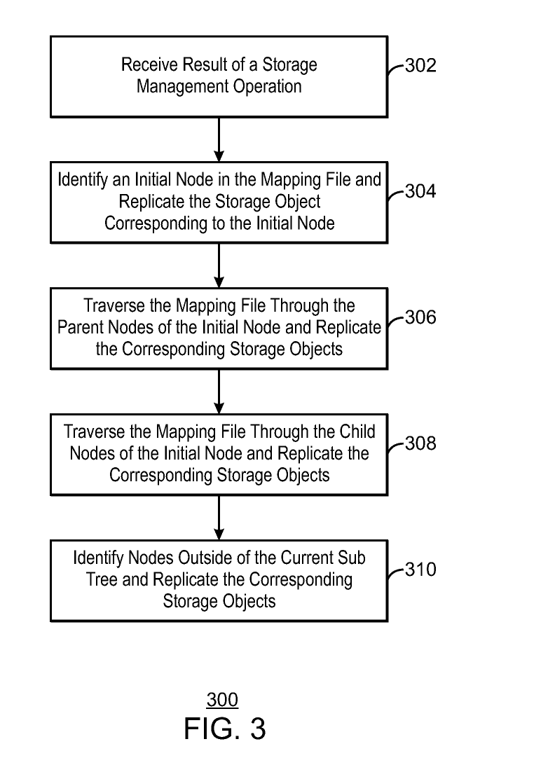

FIG. 3 is a process flow diagram of a method for collecting configuration information from the storage network, in accordance with an exemplary embodiment of the present techniques. The method 300 may be performed, for example, by the storage manager shown in FIG. 1. The method 300 may begin at block 302, wherein the result of a storage management operation is received. The storage management operation may be performed by the storage manager 116, for example, at the direction of a system administrator. The storage management operation may be any a suitable type of operation that effects the configuration of the storage network system 100. Examples of storage management operations include defining storage pools from the raw storage resources of the storage network system 100, provisioning a volume from a storage pool, reconfiguring a volume such as by changing a redundancy level associated with the volume, and adding a new storage network device to the storage network system 100, among others. The result of the storage management operation may include an identification of the storage object that was the subject of the storage management operation or was immediately affected by the storage management operation. For example, if the storage management operation is a volume provisioning, the result of the storage management operation may include an identifier that uniquely identifies the new storage volume.

At block 304, an initial node may be identified in the mapping file 122. The initial node is the node that corresponds with the storage object immediately affected by the storage management operation. For example, in the case of a volume provisioning operation, the initial node may be the volume node 220. Once the initial node is identified, the storage object corresponding to the initial node may be replicated according to the instructions contained within the initial node. To replicate the storage object, the storage network devices corresponding to the storage object may be inspected in order to obtain configuration information from the storage network devices. The collected configuration information can then be stored to the object model 118 that represents the storage network system 100. At blocks 306, 308, and 310, the discovery engine traverses the mapping file 122 to identify other objects within the storage network system 100 that may have been affected by the storage management operation. It will be appreciated that blocks 306, 308, and 310 may be processed in an order.

At block 306, the discovery engine 120 traverses the mapping file 122 upward to parents of the initial node. For example, if the storage management operation directly related to a volume, the discovery engine 120 may traverse the mapping file 122 from the volume node 220 to the concrete pool node 208, then to the primordial pool node 204, and so on until the top of the mapping file 122 has been reached. At each traversal of the mapping file 122, the discovery engine 120 uses the instructions contained within the node to collect the configuration information associated with that node. The collected information is used to replicate the storage object in the object model 118.

At block 308, the discovery engine 120 traverses the mapping file 122 downward to children of the initial node. For example, if the storage management operation directly related to a volume, the discovery engine 120 may traverse the mapping file 122 from the volume node 220 to the volume settings node 230. Similarly, if the storage management operation directly affected a concrete storage pool such as by adding additional storage disks to the concrete storage pool, the the discovery engine 120 may traverse the mapping file 122 from the concrete pool node 208 (which is the initial node in this example) to the children of the concrete pool node 208, namely, the pool capabilities node 218, the volume node 220, the disk extents node 222, and the disk group extents node 224. The discovery engine 120 may also traverse the next generation of child nodes, in other words, the children of the children, and so on until the reaching the bottom-most nodes in each branch. At each traversal of the mapping file 122, the discovery engine 120 uses the instructions contained within the node to collect the configuration information associated with that node. The collected information is used to replicate the storage object in the object model 118.

At block 310, the discovery engine identifies additional nodes that are outside the sub tree of the initial node and represent storage objects that have been affected by the storage management operation. Such additional nodes may be identified by including a target attribute in the initial node. The discovery engine 120 traverses the mapping file 122 to these additional nodes and again the discovery engine uses the instructions contained within the nodes to collect the configuration information associated with those nodes. The collected information is used to replicate the corresponding storage objects in the object model 118.

The result of the discovery process is a limited update of the storage network system's object model 118, wherein storage objects affected by the storage management operation will be updated and storage objects unaffected by the storage management operation will retain their previous configuration parameters. Only those storage devices that may have been affected by the storage management operation are inspected. Furthermore, the limited update may be triggered by a storage management operation, rather than being initiated periodically according to a pre-determined schedule.

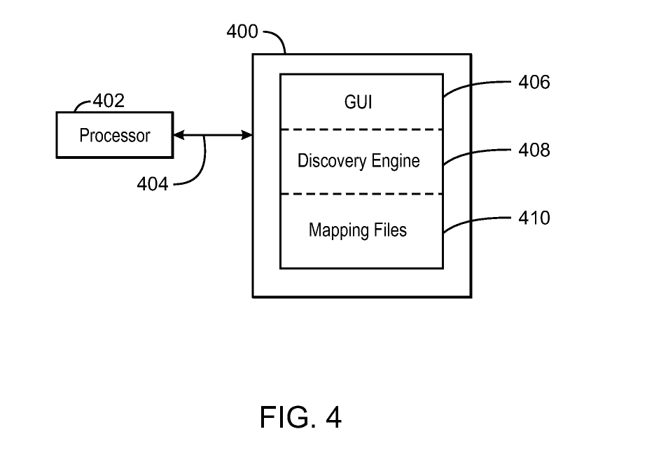

FIG. 4 is a block diagram of a non-transitory, computer readable medium that stores code for collecting configuration information from the storage network system, in accordance with embodiments. The non-transitory, computer-readable medium is generally referred to by the reference number 400. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to perform storage monitoring and management processes, in accordance with embodiments. For example, the computer-readable medium 400 may include a GUI module 406 that includes instructions for generating a graphical user interface of the storage manager utility shown in FIG. 1. The GUI module 406 enables a user such as a system administrator to view and edit the configuration of the storage network system. The GUI module can use the object model 118 of the storage network system 100 to generate the graphical user interface. The computer-readable medium 400 may also include a discovery engine 408, which may be the discovery engine 120 shown in FIG. 1. The discovery engine 408 is configured to inspect the storage network devices included in the storage network system 100 and replicate the collected information to an object model 118 of the storage network system 100, in accordance with the techniques described herein. The computer-readable medium 400 may also include the mapping files 410, which may the mapping files 122 shown in FIG. 1. As discussed above, a selected one of the mapping files 122 can be used to guide the discovery process performed by the discovery engine 408.

While the present techniques may be susceptible to various modifications and alternative forms, the exemplary embodiments discussed above have been shown only by way of example. It is to be understood that the technique is not intended to be limited to the particular embodiments disclosed herein. Indeed, the present techniques include all alternatives, modifications, and equivalents falling within the true spirit and scope of the appended claims.

What is claimed is:

1. A storage network system, comprising:
a plurality of storage network devices;
a storage manager communicatively coupled to the plurality of storage network devices and comprising a discovery engine configured to collect configuration information from the plurality of storage network devices;
an object model that represents the storage network system and is updated based on the configuration information collected by the discovery engine; and
a mapping file that guides the discovery engine during an update of the object model;
wherein the discovery engine is triggered to perform a limited update of the object model upon the completion of a storage management operation.

2. The storage network system of claim 1, wherein the discovery engine receives a result of the storage management operation and identifies a initial node of the mapping file, the initial node corresponding to a storage object that was the subject of the storage management operation, the initial node being the starting point for the update of the object model.

3. The storage network system of claim 2, wherein the discovery engine traverses the mapping file from the initial node to parent nodes of the initial node and from the initial node to child nodes of the initial node.

4. The storage network system of claim 3, wherein at each traversal of the mapping file, the discovery engine advances to a next node and replicates a storage object corresponding to the next node based on instructions contained in the next node.

5. The storage network system of claim 1, wherein the mapping file identifies relationships between the storage objects and contains instructions that guide the discovery engine to collect configuration information from the storage network devices.

5. The storage network system of claim 1, wherein the discovery engine is configured to collect configuration information from the plurality of storage network devices by sending SMI-S based information requests to the one or more of the storage network devices.

6. The storage network system of claim 1, wherein the mapping file is a eXtensible Markup Language (XML) file based on a Common Information Model (CIM).

7. The storage network system of claim 1, wherein, at each node of the mapping file, the storage network devices corresponding to the node are inspected to obtain the configuration information for the storage network devices.

9. The storage network system of claim 1, wherein the storage network devices comprise at least one of a Storage Array Network (SAN) switch, and a disk array.

10. The storage network system of claim 1, wherein the object model comprises storage objects, the storage objects comprising at least one of a storage pool and a volume.

11. A method for updating configuration information of a storage network system, comprising:
receiving a result of a storage management operation performed on the storage network system, wherein the result of the storage management operation identifies a storage object immediately affected by the storage management operation;
identifying an initial node corresponding to the storage object in a mapping file and replicating the storage object based on instructions contained in the initial node;
traversing the mapping file starting from the initial node to identify additional storage objects that have been affected by the storage management operation and replicating the additional storage objects.

12. The method of claim 11, wherein traversing the mapping file comprises identifying a parent node of the initial node, the method comprising replicating a parent storage object corresponding to the parent node based on instructions contained in the parent node.

13. The method of claim 11, wherein traversing the mapping file comprises identifying a child node of the initial node, the method comprising replicating a child storage object corresponding to the child node based on instructions contained in the child node.

14. The method of claim 11, wherein traversing the mapping file comprises identifying a storage object corresponding to a node that is outside the subtree of the initial node.

15. The method of claim 11, wherein storage objects that are not affected by the storage management operation are not updated.

16. The method of claim 11, wherein the storage management operation is a volume provisioning operation and the initial node corresponds with a volume created by the volume provisioning operation.

17. A non-transitory, computer-readable medium, comprising code configured to direct a processor to:
receive a result of a storage management operation performed on a storage network system, wherein the result of the storage management operation identifies a storage object immediately affected by the storage management operation;
identify an initial node corresponding to the storage object in a mapping file and replicate the storage object based on instructions contained in the initial node; and
traverse the mapping file starting from the initial node to identify additional storage objects that have been affected by the storage management operation and replicate the additional storage objects.

18. The method of claim 17, wherein traversing the mapping file comprises:
traversing from the initial node to parent nodes of the initial node and child nodes of the initial node; and
at each parent node and child node, collecting configuration information from storage network devices corresponding to the node in accordance instructions contained in the node.

19. The method of claim 17, wherein traversing the mapping file comprises identifying a node that is outside the subtree of the initial node.

20. The method of claim 17, wherein the storage management operation is a volume provisioning operation and the initial node corresponds with a volume created by the volume provisioning operation.
